(19) United States
(12) Patent Application Publication
(10) Pub. No.: US 2026/0055214 A1
(43) Pub. Date: Feb. 26, 2026

(54) PROCESS FOR PREPARING A LONG CHAIN BRANCHED POLYPROPYLENE COMPOSITION

(71) Applicant: BOREALIS AG, Vienna (AT)

(72) Inventors: Jingbo Wang, Linz (AT); Antti Tapio Tynys, Linz (AT)

(21) Appl. No.: 19/103,273

(22) PCT Filed: Aug. 16, 2023
(86) PCT No.: PCT/EP2023/072499

§ 371 Date: Feb. 12, 2025

(30) Foreign Application Priority Data
Aug. 19, 2022 (EP) 22191225.6

(51) Int. Cl. C08F 10/06

(52) U.S. Cl. CPC C08F 10/06

(57) ABSTRACT

A process is provided for preparing a long chain branched polypropylene composition. The process comprises the steps of: i) providing a long chain branched polypropylene. ii) providing a poly functionally unsaturated compound, iii) optionally providing a radical initiator, iv) combining the long chain branched polypropylene, the polyfunctionally unsaturated compound, and the optional radical initiator, to provide a mixture, v) melt extruding the mixture to obtain a long chain branched polypropylene composition. A long chain branched polypropylene composition is provided which is obtainable by melt extruding a mixture comprising: (a) a long chain branched polypropylene, (b) a polyfunctionally unsaturated compound, and (c) optionally a radical initiator. Also provided is a use of a poly functionally unsaturated compound for reducing the loss of melt strength of a long-chain branched polypropylene, and preferably a reused long chain branched polypropylene, during melt extrusion.

### TECHNICAL FIELD

The present application relates to a process for preparing a long chain branched polypropylene composition and to a long chain branched polypropylene composition as such. The present application further relates to a process for reducing the loss of melt strength of a long chain branched polypropylene during melt extrusion.

### BACKGROUND

Long chain branched polypropylenes are a group of polypropylenes which have a comparatively high melt strength. Long chain branched polypropylenes are used for many applications where a polypropylene with a high melt strength is needed like foaming application.

For example, WO 2012/049690 A1 describes a process for preparing high melt strength propylene polymers. Furthermore, WO2011086581A1 describes a process of modifying propylene polymers via melt grafting of polyfunctional monomer (PFMs).

Like other polymeric materials, long chain branched polypropylenes typically degrade during melt extrusion processing. It is a common problem that a long chain branched polypropylene which has already been subjected to two or more melt extrusion processes has lost its melt strength to a significant extent. Thereby, the degraded long chain branched polypropylene can no longer serve its original purpose when the material is recycled. Hence, degradation and loss of melt strength limits the reusability of long chain branched polypropylene as the reused material may no longer have sufficient melt strength to provide its full functionality.

Therefore, there is a continuing need in the art to provide a process which can reduce degradation and/or loss of melt strength of long chain branched polypropylene during processing as much as possible.

It is one object of the present application to provide a process for preparing a long chain branched polypropylene composition. Another object of the present application is to provide a long chain branched polypropylene composition.

### SUMMARY OF INVENTION

One aspect of the present invention provides a process for preparing a long chain branched polypropylene composition. The process comprises the steps of:
i) providing a long chain branched polypropylene,
ii) providing a polyfunctionally unsaturated compound,
iii) optionally providing a radical initiator,
iv) combining the long chain branched polypropylene, the polyfunctionally unsaturated compound, and the optional radical initiator, to provide a mixture,
v) melt extruding the mixture to obtain a long chain branched polypropylene composition.

One finding of the inventors is that the loss of melt strength during melt extrusion can be reduced when combining a long chain branched polypropylene, such as a reused or recycled long chain branched polypropylene, with a polyfunctionally unsaturated compound. It has further been found that addition of the polyfunctionally unsaturated compound, and optionally a radical initiator, can decrease the gel content, as determined by e.g. the hot xylene insoluble fraction. This finding was unexpected because addition of polyfunctionally unsaturated compounds in extrusion processes typically leads to cross-linking of polymer which in turn would increase gel content. Increased gel content is not desirable as gel is usually not dispersible anymore and therefore leads to defects of materials in many applications, like preparation of film and fiber and sometimes even in moulding.

Another aspect of the present invention provides a long chain branched polypropylene composition. The polypropylene composition is obtainable by melt extruding a mixture comprising:
(a) a long chain branched polypropylene,
(b) a polyfunctionally unsaturated compound, and
(c) optionally a radical initiator.

Another aspect of the present invention provides a use of a polyfunctionally unsaturated compound for reducing the loss of melt strength of a long chain branched polypropylene, and preferably a reused long chain branched polypropylene, during melt extrusion. Also provided herein is a process for reducing the loss of melt strength of long chain branched polypropylene during melt extrusion, the process comprising the steps of i) combining a long chain branched polypropylene with a polyfunctionally unsaturated compound, and optionally with a radical initiator, to provide a mixture, ii) melt extruding the mixture.

Further embodiments of the invention are defined in the dependent claims.

According to one embodiment of the invention, the long chain branched polypropylene is a reused long chain branched polypropylene.

According to one embodiment of the invention, the long chain branched polypropylene is a long chain branched propylene homopolymer.

According to one embodiment of the invention, the long chain branched polypropylene has one or more of, and preferably all of, the following properties:
i) a melt flow rate MFR₂ (ISO 1133, 2.16 kg load, 230° C.) in the range of 0.5 to 10 g/10 min, preferably in the range of 1.5 to 7.5 g/10 min, and more preferably of 2.5 to 6.0 g/10 min,
ii) a melt strength F₃₀ (ISO 16790:2005) in the range of 5.0 to 50.0 cN, preferably 10.0 to 50.0 cN, more preferably in the range of 15.0 to 35.0 cN, and even more preferably in the range of 20.0 to 30.0 cN,
iii) a melt extensibility v₃₀ (ISO 16790:2005) in the range of 200 to 300 mm/s, preferably 220 to 290 mm/s, and more preferably 240 to 280 mm/s.

According to one embodiment of the invention, the polyfunctionally unsaturated compound is a polyfunctional (meth)acrylate compound, and preferably a polyfunctional acrylate monomer.

According to one embodiment of the invention, the mixture provided in step iv) comprises a radical initiator, preferably a peroxide radical initiator, and more preferably an organic peroxide radical initiator.

According to one embodiment of the invention, step iii) is not carried out, and the mixture provided in step iv) does not contain a radical initiator.

According to one embodiment of the invention, the mixture provided in step iv) comprises
(a) 95.0 to 99.95 wt. %, preferably 97.5 to 99.95 wt. %, and more preferably 99.0 to 99.90 wt. %, of the long chain branched polypropylene,
(b) 0.05 to 5.0 wt. %, preferably 0.05 to 2.5 wt. %, and even more preferably 0.10 to 1.0 wt. %, of the polyfunctionally unsaturated compound, and
(c) optionally 0.0001 to 0.20 wt. %, preferably 0.004 to 0.15 wt. %, and more preferably 0.004 to 0.10 wt. %, of a radical initiator,
wherein all weight amounts are based on the overall weight of the mixture provided in step iv), and optionally wherein the weight amounts of components (a) to (c) add up to 100 wt. %.

According to one embodiment of the invention, the mixture provided in step iv) comprises the components provided in step i) to iii) in the relative amounts of:
(a) 95.0 to 99.95 parts by weight (pbw), preferably 97.5 to 99.95 parts by weight (pbw), and more preferably 99.0 to 99.90 parts by weight (pbw), like in the range of 99.25 to 99.90 parts by weight (pbw), of the long chain branched polypropylene,
(b) 0.05 to 5.0 parts by weight (pbw), preferably 0.05 to 2.5 parts by weight (pbw), and even more preferably 0.10 to 1.0 parts by weight (pbw), like in the range of 0.10 to 0.75 parts by weight (pbw), of the polyfunctionally unsaturated compound, and
(c) optionally 0.0001 to 0.20 parts by weight (pbw), preferably 0.004 to 0.15 parts by weight (pbw), and more preferably 0.004 to 0.10 parts by weight (pbw), like in the range of 0.005 to 0.10 parts by weight (pbw), of a radical initiator.

According to one embodiment of the invention, the long chain branched polypropylene composition obtained in step v) has a melt strength F₃₀ (ISO 16790:2005) which is increased, and preferably increased by at least 3.0%,
when compared in a comparative test to the melt strength F₃₀ (ISO 16790:2005) of a comparative long chain branched polypropylene composition which is obtained by a comparative process which does not use the polyfunctionally unsaturated compound.

According to one embodiment of the invention, the long chain branched polypropylene composition obtained in step v) has a xylene hot insoluble fraction (XHI) which is reduced by at least 50%, preferably at least 60%, more preferably at least 80%, and even more preferably at least 90%,
when compared in a comparative test to the xylene hot insoluble fraction (XHI) of a comparative long chain branched polypropylene composition which is obtained by a comparative process which does not use the polyfunctionally unsaturated compound.

According to one embodiment of the invention, the long chain branched polypropylene composition has one or more of, and preferably all of, the following properties:
i) a melt flow rate MFR₂ (ISO 1133, 2.16 kg load, 230° C.) in the range of 3.0 to 30 g/10 min, preferably in the range of 5.0 to 25.0 g/10 min, and more preferably of 8.0 to 20.0 g/10 min,
ii) a melt strength F₃₀ (ISO 16790:2005) in the range of 3.0 to 25.0 cN, preferably in the range of 4.0 to 15.0 cN, and more preferably in the range of 4.0 to 7.5 cN,
ii) a melt extensibility v₃₀ (ISO 16790:2005) in the range of 200 to 290 mm/s, preferably in the range of 220 to 290 mm/s, and more preferably in the range of 240 to 280 mm/s.

According to one embodiment of the invention, the long chain branched polypropylene composition has a xylene hot insoluble fraction (XHI) of less than 0.10 wt. %, preferably of less than 0.05 wt. %, and more preferably of 0.02 wt. % or less, based on the total weight of the long chain branched polypropylene composition.

According to one embodiment of the invention, the long chain branched polypropylene composition comprises at least 95.0 wt. %, preferably at least 97.5 wt. %, and more preferably at least 98.0 wt. % of a long chain branched polypropylene, based on the total weight of the long chain branched polypropylene composition.

Where the term “comprising” is used in the present description and claims, it does not exclude other non-specified elements of major or minor functional importance. For the purposes of the present invention, the term “essentially consisting of” and “consisting of” are considered to be specific embodiments of the term “comprising of”. If hereinafter a group is defined to comprise at least a certain number of features or embodiments, this is also to be understood to disclose a group, which optionally essentially consists only of these features or embodiments or consists only of these features or embodiments. Whenever the terms “including” or “having” are used, these terms are meant to be equivalent to “comprising” as defined above.

In the following, the present invention is described in more detail.

### DETAILED DESCRIPTION

### Process for Preparing a Long Chain Branched Polypropylene Composition

One aspect of the present invention provides a process for preparing a long chain branched polypropylene composition. The process comprises the steps of:
i) providing a long chain branched polypropylene,
ii) providing a polyfunctionally unsaturated compound,
iii) optionally providing a radical initiator,
iv) combining the long chain branched polypropylene, the polyfunctionally unsaturated compound, and the optional radical initiator, to provide a mixture,
v) melt extruding the mixture to obtain a long chain branched polypropylene composition.

The process is preferably carried out with a purpose to reduce the loss of melt strength of the long chain branched polypropylene during melt extrusion, i.e. during melt mixing and/or melt compounding in an extruder. Hence, the process is preferably a process for preparing a long chain branched polypropylene composition having a reduced loss of melt strength.

The “reduced loss of melt strength” can be determined by comparison of a long chain branched polypropylene composition which is obtained by the inventive process with a long chain branched polypropylene composition which is obtained in a comparative test by a comparative process which does not use the polyfunctionally unsaturated compound.

### Step i)

In step i) of the process, a long chain branched polypropylene is provided. Long chain polypropylenes are known to the skilled person.

Long chain branched polypropylene differs from a linear polypropylene in that the polypropylene backbone contains long side chains whereas a non-branched polypropylene, i.e. a linear polypropylene, does not contain long side chains. The long side chains branching out from the polymer backbone have significant impact on the rheology of the polypropylene. Accordingly, linear polypropylenes and long chain branched polypropylenes can be clearly distinguished by e.g. their flow behavior under stress (e.g. a ratio of polymer melt viscosities measured under differing loads). Additionally or alternatively, long chain branching can be determined by analysing the content of long chain branches by NMR and/or by measuring the long chain branching index g′ by using e.g. SEC/VISC-LS (size exclusion chromatography/viscometry-light scattering) as known in the art. Branching index g′ is a parameter of the degree of branching. The branching index g′ correlates with the amount of branches of a polymer. A low g′-value is an indicator for a highly branched polymer. In other words, if the g′-value decreases, the branching of the polypropylene increases. For instance, the value of g′ of at least 0.96, such as at least 0.97 or at least 0.98 typically indicates that long chain branches are not present. On the other hand, a value of g′ of 0.9 or less (e.g. 0.6 to 0.9), such as 0.8 or less, typically indicates that the polymer contains long chain branches.

The long chain branched polypropylene provided in step i) of the process preferably has a branching index g′ of 0.9 or less, like in the range from 0.6 to 0.9. The long chain branching index g′ can be determined by using e.g. SEC/VISC-LS (size exclusion chromatography/viscometry-light scattering) as known in the art. Further details regarding branching index g′ and methods for its determination are described, for example, in the section “Measuring methods” of EP3280748 B1, which is incorporated herein by reference.

Due to the specific melt strength properties, long chain branched polypropylenes are also referred to in the art as high melt strength polypropylenes.

Long chain branching can be generally achieved by using specific catalysts, i.e. specific single-site catalysts, or by chemical modification. Concerning the preparation of a long chain branched polypropylene obtained by the use of a specific catalyst reference is made to EP 1 892 264. With regard to a long chain branched polypropylene obtained by chemical modification it is referred to, for instance, EP 0 787 750, EP 0 879 830 A1 and EP 0 890 612 A2

Long chain branched polypropylenes typically have a comparatively low melt flow rate combined with high melt strength and a high melt extensibility.

The long chain branched polypropylene provided in step i) can generally be any type of long chain branched polypropylene, preferably any type of long chain branched polypropylene which suffers from degradation during melt extrusion. Hence, the long chain branched polypropylene can be a new long chain branched polypropylene (also referred to in the art as “virgin grade”) or a reused long chain branched polypropylene.

The long chain branched polypropylene provided in step i) is preferably a reused long chain branched polypropylene. A “reused long chain branched polypropylene” is preferably understood as a long chain branched polypropylene which has already been subjected to at least one melt extrusion process, e.g. one or two melt extrusion processes. Thus, the long chain branched polypropylene can be a degraded long chain branched polypropylene.

The reused long chain branched polypropylene can be collected from different sources, like from a waste stream or from by-products of production which do not meet a given specification (“off-spec products”, like edges in sheet production). The reused long chain branched polypropylene provided in step i) of the process may be provided as single component or in another comparatively pure form containing not more than 5.0 wt. % of other components, based on the entire weight of the material comprising the reused long chain branched polypropylene. It is however also possible that the reused long chain branched polypropylene provided in step i) of the process is provided in form of a blend with other components, like polymer blending partners.

The reused long chain branched polypropylene provided in step i) can be a reused long chain branched polypropylene which has lost at least 10% (e.g. from 10 to 95%), like at least 20%, of its original melt strength, determined as melt strength F₃₀ (ISO 16790:2005). The “original melt strength” is the melt strength of the new long chain branched polypropylene (also referred to in the art as “virgin grade”), i.e. which has not yet been subjected to a melt extrusion process.

In case the long chain branched polypropylene provided in step i) is a reused long chain branched polypropylene, process step i) preferably comprises the steps of:
i-1) melt extruding a long chain branched polypropylene or a composition comprising a long chain branched polypropylene,
i-2) collecting the melt extruded long chain branched polypropylene or the melt extruded composition comprising the long chain branched polypropylene, optionally in form of a waste product or a by-product, to provide a reused long chain branched polypropylene or a composition comprising a reused long chain branched polypropylene.

Thus, the long chain branched polypropylene provided in step i) is preferably a reused long chain branched polypropylene, which is obtained or obtainable by a process comprising the steps of:
i-1) melt extruding a long chain branched polypropylene or a composition comprising a long chain branched polypropylene,
i-2) collecting the melt extruded long chain branched polypropylene or the melt extruded composition comprising the long chain branched polypropylene, optionally in form of a waste product or a by-product, to provide a reused long chain branched polypropylene or a composition comprising a reused long chain branched polypropylene.

It is preferred that the long chain branched polypropylene provided in step i), more preferably the reused long chain branched polypropylene, has specific properties.

According to one embodiment of the invention, the long chain branched polypropylene provided in step i), preferably the reused long chain branched polypropylene, has a melt flow rate MFR₂ (ISO 1133, 2.16 kg load, 230° C.) in the range of 0.5 to 10 g/min, preferably in the range of 1.5 to 7.5 g/10 min, and more preferably of 2.5 to 6.0 g/10 min, like in the range of 3.0 to 5.0 g/10 min. For example, the melt flow rate MFR₂ (ISO 1133, 2.16 kg load, 230° C.) can be about 3.9 g/10 min.

According to one embodiment of the invention, the long chain branched polypropylene provided in step i), preferably the reused long chain branched polypropylene, has a melt strength F₃₀ (ISO 16790:2005) in the range of 5.0 to 50.0 cN (e.g., 5.0 to 30.0 cN), preferably 10.0 to 50.0 cN, more preferably in the range of 15.0 to 35.0 cN, and even more preferably in the range of 20.0 to 30.0 cN, like in the range of 25.0 to 28.0 cN. For example, the melt strength F₃₀ (ISO 16790:2005) can be about 26 cN.

According to one embodiment of the invention, the long chain branched polypropylene provided in step i), preferably the reused long chain branched polypropylene, has a melt extensibility v₃₀ (ISO 16790:2005) in the range of 200 to 300 mm/s, preferably 220 to 290 mm/s, and more preferably 240 to 280 mm/s, like in the range of 250 to 270 mm/s. For example, the melt extensibility v30 (ISO 16790:2005) can be about 268 mm/s.

It is preferred that the long chain branched polypropylene provided in step i), preferably the reused long chain branched polypropylene, is characterized by a combination of properties. Hence, according to one preferred embodiment of the invention, the long chain branched polypropylene provided in step i), preferably the reused long chain branched polypropylene, has the following properties i) and ii), and more preferably all of the following properties i) to iii):
i) a melt flow rate MFR₂ (ISO 1133, 2.16 kg load, 230° C.) in the range of 0.5 to 10 g/10 min, preferably in the range of 1.5 to 7.5 g/10 min, and more preferably of 2.5 to 6.0 g/10 min, like in the range of 3.0 to 5.0 g/10 min,
ii) a melt strength F₃₀ (ISO 16790:2005) in the range of 5.0 to 50.0 cN (e.g., 5.0 to 30.0 cN), preferably 10.0 to 50.0 cN, more preferably in the range of 15.0 to 35.0 cN, and even more preferably in the range of 20.0 to 30.0 cN, like in the range of 25.0 to 28.0 cN,
iii) a melt extensibility v₃₀ (ISO 16790:2005) in the range of 200 to 300 mm/s, preferably 220 to 290 mm/s, and more preferably 240 to 280 mm/s, like in the range of 250 to 270 mm/s.

The long chain branched polypropylene provided in step i) is not specifically limited in terms of the linear polypropylene which forms its longest chain or backbone. The long chain branched polypropylene provided in step i) can be a long chain branched propylene copolymer or a long chain branched propylene homopolymer.

It is preferred that the long chain branched polypropylene provided in step i), preferably the reused long chain branched polypropylene, is a long chain branched propylene homopolymer.

In case the long chain branched polypropylene is a long chain branched polypropylene which is (originally) obtained by chemical modification of a linear polypropylene, the definition of propylene homopolymer and propylene copolymer is to be understood to refer to the linear polypropylene which is used to obtain the long chain branched polypropylene by chemical modification, e.g. with bifunctionally unsaturated monomer(s) and/or multifunctionally unsaturated low molecular weight polymer(s) in reactive extrusion.

As described above, the long chain branched polypropylene provided in step i) is preferably a reused long chain branched polypropylene. The reused long chain branched polypropylene is preferably obtained from a non-used long chain branched polypropylene, i.e. a long chain branched polypropylene not previously melt extruded (“virgin grade” material), which is referred to herein below as “non-used long chain branched PP”.

The non-used long chain branched PP can have one or more of, and preferably all of, the following properties:
i) a melt flow rate MFR₂ (ISO 1133, 2.16 kg load, 230° C.) in the range of 0.5 to 5.0 g/10 min, preferably in the range of 1.0 to 4.0 g/10 min, and more preferably of 1.5 to 3.0 g/10 min,
ii) a melt strength F₃₀ (ISO 16790:2005) of more than 25.0 cN, preferably in the range of more than 25.0 to 50.0 cN, and more preferably in the range of 30.0 to 40.0 cN, and
iii) a melt extensibility v₃₀ (ISO 16790:2005) in the range of 200 to 300 mm/s, preferably 220 to 290 mm/s, and more preferably 220 to 270 mm/s.

The non-used long chain branched PP can have a melting point of in the range of 140 to 175° C., preferably in the range of 145 to 170° C., and most preferably in the range of 150 to 167° C. The crystallization temperature may be in the range of 110 to 140° C., preferably in the range of 115 to 135° C., and most preferably in the range of 120 to 132° C.

In one preferred embodiment, the long chain branched polypropylene provided in step i) is a reused long chain branched polypropylene, which is obtained or obtainable by a process comprising the steps of:
i-1) melt extruding a non-used long chain branched polypropylene or a composition comprising a non-used long chain branched polypropylene, wherein the non-used long chain branched polypropylene is preferably as defined above,
i-2) collecting the melt extruded long chain branched polypropylene or the melt extruded composition comprising the long chain branched polypropylene obtained in step i-2), optionally in form of a waste product or a by-product, to provide a reused long chain branched polypropylene or a composition comprising a reused long chain branched polypropylene.

The non-used long chain branched PP can be obtained by treating linear polypropylene with a radical-forming agent, preferably in the presence of bifunctionally unsaturated monomer(s) and/or multifunctionally unsaturated low molecular weight polymer(s).

The multifunctionally unsaturated low molecular weight polymer(s) preferably have a number average molecular weight (Mn) ≤10000 g/mol. The bifunctionally unsaturated monomers may be selected from divinyl compounds, allyl compounds, dienes, and the like. A suitable method to obtain the non-used long chain branched PP, is for instance disclosed in EP 0 787 750, EP 0 879 830 A1 and EP 0 890 612 A2.

A suitable non-used long chain branched PP is WB140HMS™ commercially available from Borealis AG. Thus, a suitable reused long chain branched polypropylene provided in step i) is a long chain branched polypropylene WB140HMS™ which is reused after a melt extrusion process, e.g. one melt extrusion process, and which is optionally provided in form of and/or as part of a waste product or a by-product.

### Step ii)

In step ii) of the process, a polyfunctionally unsaturated compound is provided. The polyfunctionally unsaturated compound can generally be any compound which can react with long chain branched polypropylene during melt extrusion, optionally under radical reaction conditions. Preferably, the polyfunctionally unsaturated compound is a liquid or a solid, and more preferably a liquid, like a low-volatile liquid.

The polyfunctionally unsaturated compound is preferably a compound which has two or more (e.g. 2 to 4) non-aromatic carbon-carbon (C-C) double bonds. The two or more non-aromatic C-C double bonds are preferably terminal C-C double bonds. A skilled person can identify a terminal double bond in a chemical structure. A terminal C-C double bond is a C-C double bond, of which one C atom has two hydrogen substituents.

The polyfunctionally unsaturated compound may be a monomer, an oligomer or a polymer, and preferably is a monomer. A monomer is typically a small organic compound which can be subjected to a polymerization reaction.

Preferably, the polyfunctionally unsaturated compound is a polyfunctionally unsaturated monomer having a molecular weight of less than 500 g/mol, and more preferably 400 g/mol or less (e.g. in the range of 100 to 400 g/mol).

The polyfunctionally unsaturated compound is preferably a branched-chain compound.

According to one embodiment, the polyfunctionally unsaturated compound is a compound which has two or more, preferably two to four (e.g. three), terminal C-C double bonds, and which has a molecular weight of less than 500 g/mol, and preferably 400 g/mol or less (e.g. in the range of 100 to 400 g/mol).

The polyfunctionally unsaturated compound is preferably a polyfunctionally unsaturated (meth)acrylate compound, more preferably a polyfunctionally unsaturated acrylate compound, and even more preferably a polyfunctionally unsaturated acrylate monomer.

The polyfunctionally unsaturated (meth)acrylate compound is preferably an ester of a di-, tri-, or tetraol with (meth)acrylic acid, and more preferably with acrylic acid. Thus, the polyfunctionally unsaturated (meth)acrylate compound can be, but is not limited to, a di-(meth)acrylate, a tri-(meth)acrylate, or tetra-(meth)acrylate, and preferably a di-acrylate, a tri-acrylate, or tetra-acrylate.

According to one embodiment, the polyfunctionally unsaturated compound is a polyfunctionally unsaturated (meth)acrylate compound, preferably a polyfunctionally unsaturated acrylate compound, which comprises two or more, preferably two to four (e.g. three), acrylate esters.

According to one preferred embodiment, the polyfunctionally unsaturated compound is a polyfunctionally unsaturated (meth) acrylate compound, preferably a polyfunctionally unsaturated acrylate compound, which comprises two or more, preferably two to four (e.g.

three), acrylate esters, and which has a molecular weight of less than 500 g/mol, and preferably 400 g/mol or less (e.g. in the range of 100 to 400 g/mol).

For example, the polyfunctionally unsaturated compound can be a triacrylate. According to one preferred embodiment, the polyfunctionally unsaturated compound is a polyfunctionally unsaturated (meth) acrylate compound, preferably a polyfunctionally unsaturated acrylate compound, which comprises three acrylate esters, and which has a molecular weight of less than 500 g/mol, and preferably 400 g/mol or less (e.g. in the range of 100 to 400 g/mol).

A suitable polyfunctionally unsaturated compound is trimethylolpropane triacrylate, also referred to in the art as TMPTA.

### Step iii)

In optional step iii) of the process, a radical initiator is provided. Radical initiators are known to the skilled person. Radical initiators may be, for example, peroxides, azo compounds, nitroxides, trialkylboranes, and the like. The radical initiator provided in step iii) is preferably a radical initiator which is effective when used in an amount in the range of 1 to 2000 ppm.

The radical initiator can be any radical initiator which is suitable for starting a radical reaction between a polyfunctionally unsaturated compound, preferably a polyfunctionally unsaturated (meth)acrylate compound, and a polypropylene, preferably a long chain branched polypropylene.

Preferably, the radical initiator is a peroxide radical initiator, and more preferably an organic peroxide radical initiator. The organic peroxide radical initiator can be, but is not limited to, a peroxy carbonate compound, a peroxy ether compound, a peroxy ester compound, or a peroxy acid compound. In one embodiment, the radical initiator is a

A suitable radical initiator is tert-butylperoxy isopropyl carbonate.

### Step iv)

In step iv) of the process, the long chain branched polypropylene provided in step i), the polyfunctionally unsaturated compound provided in step ii), and the optional radical initiator optionally provided in step iii), are combined to provide a mixture.

The combination of the components can be carried out by any means known in the art.

The components provided in steps i) to iii) can be mixed or blended outside of an extruder by conventional means. Thus, the components provided in steps i) to iii) can be pre-mixed or pre-blended in step iv) and before step v), i.e. the components are pre-mixed in step iv) before being fed to an extruder. It is also possible to provide the components provided in steps ii) and iii) together in form of a masterbatch.

Alternatively, the components provided in steps i) to iii) can be combined in an extruder, like in the feedscrew of the extruder. In such case, the components are not pre-mixed or pre-blended before being fed to the extruder but are added as single components to the extruder. It is also possible to pre-mix or pre-blend selected components and then combine the pre-mix or pre-blend with the other components in the extruder to provide the mixture.

In general, the mixture provided in step iv) is not necessarily limited to components provided in steps i) to iii). Additional components may be added to the components provided in steps i) to iii) or may be present with the components provided in steps i) to iii).

Hence, the mixture provided in step iv) can comprise additional components other than the components provided in steps i) to iii). The additional components can be, but are not limited, to one or more additional polymeric components and/or one or more additives.

The one or more additional polymeric components may be polymeric components which are melt-mixable and/or melt-compoundable with the long chain branched polypropylene provided in step i).

The one or more additives may be selected by the skilled person according to the needs. For example, the one or more additives can comprise a foaming agent. Foaming agents are known to the skilled person and may be selected from chemical foaming agents and physical foaming agents known in the art. Physical foaming agents can be injected into the mixture in step v).

According to one embodiment, the mixture provided in step iv) comprises polymeric material, which is different to the long chain branched polypropylene provided in step i), in an amount of 10.0 wt. % or less (e.g. 0.0 to 10.0 wt. %), based on the total weight of the mixture provided in step iv).

It is preferred that the components provided in steps i) to iii) are present in the mixture provided in step iv) in specific relative and/or overall amounts.

The long chain branched polypropylene, the polyfunctionally unsaturated compound and the optional radical initiator can be combined in the mixture in specific relative amounts.

According to one preferred embodiment, the long chain branched polypropylene provided in step i) is combined with the polyfunctionally unsaturated compound provided in step ii) in a weight ratio [long chain branched polypropylene: polyfunctionally unsaturated compound] in the range of 90.0:10.0 to 99.95:0.05, preferably 95.0:5.0 to 99.95:0.05, more preferably 97.5:2.5 to 99.95:0.05, and even more preferably 99.0:1.0 to 99.90:0.10.

According to one preferred embodiment, the mixture provided in step iv) comprises the components provided in step i) to iii) in the following relative amounts:
(a) 95.0 to 99.95 parts by weight (pbw), preferably 97.5 to 99.95 parts by weight (pbw), and more preferably 99.0 to 99.90 parts by weight (pbw), like in the range of 99.25 to 99.90 parts by weight (pbw), of the long chain branched polypropylene,
(b) 0.05 to 5.0 parts by weight (pbw), preferably 0.05 to 2.5 parts by weight (pbw), and even more preferably 0.10 to 1.0 parts by weight (pbw), like in the range of 0.10 to 0.75 parts by weight (pbw), of the polyfunctionally unsaturated compound, and
(c) optionally 0.0001 to 0.20 parts by weight (pbw), preferably 0.004 to 0.15 parts by weight (pbw), and more preferably 0.004 to 0.10 parts by weight (pbw), like in the range of 0.005 to 0.10 parts by weight (pbw), of a radical initiator.

The long chain branched polypropylene, the polyfunctionally unsaturated compound and the optional radical initiator can be combined in specific overall amounts, based on the total weight of the mixture provided in step iv).

According to one preferred embodiment of the present invention, the mixture provided in step iv) comprises
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) optionally 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv).

The radical initiator can be absent from the mixture provided in step iv), i.e. step iii) is not carried out. In said case, the mixture provided in step iv) can comprise
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene, and
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound,
wherein all weight amounts are based on the overall weight of the mixture provided in step iv).

In an alternative embodiment, the radical initiator is present in the mixture provided in step iv), i.e. step iii) is carried out. In said case, the mixture provided in step iv) can comprise
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv).

In one embodiment, the mixture provided in step iv) comprises
(a) 95.0 to 99.9499 wt. %, preferably 97.5 to 99.946 wt. %, and more preferably 99.0 to 99.896 wt. %, like in the range of 99.25 to 99.895 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv).

It is possible that no additional components other than the components provided in steps i) to iii) are present in the mixture provided in step iv). Hence, according to one embodiment, the mixture provided in step iv) essentially consists of, preferably consists of,
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) optionally 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv), and wherein the weight amounts of components (a) to (c) add up to 100 wt. %. This is to be understood in that, when the optional radical initiator is not present, the weight amounts of components (a) and (b) add up to 100 wt. %, and when the radical initiator is present, then the weight amounts of components (a) to (c) add up to 100 wt. %

According to one embodiment, the mixture provided in step iv) essentially consists of, preferably consists of,
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) optionally 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv).

In one embodiment, the mixture provided in step iv) comprises, preferably consists of,
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene, and
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound,
wherein all weight amounts are based on the overall weight of the mixture provided in step iv), and wherein the weight amounts of components (a) and (b) add up to 100 wt. %.

In an alternative embodiment, the mixture provided in step iv) comprises, preferably consists of,
(a) 95.0 to 99.95 wt. %, preferably 97.5 to 99.95 wt. %, and more preferably 99.0 to 99.90 wt. %, like in the range of 99.25 to 99.90 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv), and wherein the weight amounts of components (a) to (c) add up to 100 wt. %.

In one embodiment, the mixture provided in step iv) comprises, preferably consists of,
(a) 95.0 to 99.9499 wt. %, preferably 97.5 to 99.946 wt. %, and more preferably 99.0 to 99.896 wt. %, like in the range of 99.25 to 99.895 wt. %, of the long chain branched polypropylene,
(b) 0.05 to 5.0 wt. %, preferably 0.05 to 2.5 wt. %, and even more preferably 0.10 to 1.0 wt. %, like in the range of 0.10 to 0.75 wt. %, of the polyfunctionally unsaturated compound, and
(c) 0.0001 to 0.20 wt. %, preferably 0.004 to 0.15 wt. %, and more preferably 0.004 to 0.10 wt. %, like in the range of 0.005 to 0.10 wt. %, of a radical initiator,
wherein all weight amounts are based on the overall weight of the mixture provided in step iv).

### Step v)

In step v) of the process, the mixture provided in step iv) is melt extruded. This means the mixture provided in step iv) is subjected to a melt extrusion process. Melt extrusion processes are known in the art.

Melt extruding according to step v) typically comprises the steps of: melt mixing and/or melt compounding the mixture provided in step iv) in an extruder; extruding the melt-mixed and/or melt-compounded mixture through a die to provide the long chain branched polypropylene composition. The extruder can be, but is not limited to, a twin screw extruder, a single screw extruder, or a tandem extrusion line as known in the art.

Step v) provides a long chain branched polypropylene composition. The long chain branched polypropylene composition obtained in step v) typically has specific properties.

The long chain branched polypropylene composition can have a melt flow rate MFR₂ (ISO 1133, 2.16 kg load, 230° C.) in the range of 3.0 to 30 g/10 min, preferably in the range of 5.0 to 25.0 g/10 min, and more preferably of 8.0 to 20.0 g/10 min, like in the range of 10.0 to 20.0 g/10 min.

The long chain branched polypropylene composition can have a melt strength F₃₀ (ISO 16790:2005) in the range of 3.0 to 25.0 cN, preferably in the range of 4.0 to 15.0 cN, and more preferably in the range of 4.0 to 7.5 cN, like in the range of 5.0 to 6.5 cN.

The long chain branched polypropylene composition can have a melt extensibility v₃₀ (ISO 16790:2005) in the range of 200 to 290 mm/s, preferably in the range of 220 to 290 mm/s, and more preferably in the range of 240 to 280 mm/s, like in the range of 240 to 275 mm/s.

The long chain branched polypropylene composition can have a xylene hot insoluble fraction (XHI) of less than 0.10 wt. %, preferably of less than 0.05 wt. %, and more preferably of 0.02 wt. % or less, like in the range of 0.0 to 0.02 wt. %, based on the total weight of the long chain branched polypropylene composition.

The long chain branched polypropylene composition provided in step v) can have a specific combination of properties. Preferably, the long chain branched polypropylene composition has two or more, and more preferably all of the following properties:
i) a melt flow rate MFR₂ (ISO 1133, 2.16 kg load, 230° C.) in the range of 3.0 to 30 g/10 min, preferably in the range of 5.0 to 25.0 g/10 min, and more preferably of 8.0 to 20.0 g/10 min, like in the range of 10.0 to 20.0 g/10 min,
ii) a melt strength F₃₀ (ISO 16790:2005) in the range of 3.0 to 25.0 cN, preferably in the range of 4.0 to 15.0 cN, and more preferably in the range of 4.0 to 7.5 cN, like in the range of 5.0 to 6.5 cN,
iii) a melt extensibility v₃₀ (ISO 16790:2005) in the range of 200 to 290 mm/s, preferably in the range of 220 to 290 mm/s, and more preferably in the range of 240 to 280 mm/s, like in the range of 240 to 275 mm/s.

According to one embodiment, the long chain branched polypropylene composition has the following properties:
i) a melt flow rate MFR₂ (ISO 1133, 2.16 kg load, 230° C.) in the range of 3.0 to 30 g/10 min, preferably in the range of 5.0 to 25.0 g/10 min, and more preferably of 8.0 to 20.0 g/10 min, like in the range of 10.0 to 20.0 g/10 min,
ii) a melt strength F₃₀ (ISO 16790:2005) in the range of 3.0 to 25.0 cN, preferably in the range of 4.0 to 15.0 cN, and more preferably in the range of 4.0 to 7.5 cN, like in the range of 5.0 to 6.5 cN,
iii) a melt extensibility v₃₀ (ISO 16790:2005) in the range of 200 to 290 mm/s, preferably in the range of 220 to 290 mm/s, and more preferably in the range of 240 to 280 mm/s, like in the range of 240 to 275 mm/s, and
iv) a xylene hot insoluble fraction (XHI) of less than 0.10 wt. %, preferably of less than 0.05 wt. %, and more preferably of 0.02 wt. % or less, like in the range of 0.0 to 0.02 wt. %, based on the total weight of the long chain branched polypropylene composition.

The process as described herein can achieve one or more specific effects, and preferably can at least partially prevent a certain loss in melt strength of the melt-extruded components when compared in a comparative test to the properties of a comparative long chain branched polypropylene composition which is obtained by a comparative process which does not use the polyfunctionally unsaturated compound.

The long chain branched polypropylene composition obtained in step v) preferably has a melt strength F₃₀ (ISO 16790:2005) which is increased, and more preferably increased by at least 3.0% (e.g. in the range of 3.0 to 20% or 5.0 to 20%), when compared in a comparative test to the melt strength F₃₀ (ISO 16790:2005) of a comparative long chain branched polypropylene composition which is obtained by a comparative process which does not use the polyfunctionally unsaturated compound.

The long chain branched polypropylene composition obtained in step v) preferably has a xylene hot insoluble fraction (XHI) which is reduced by at least 50%, more preferably at least 60%, even more preferably at least 80%, and yet even more preferably at least 90%, when compared in a comparative test to the xylene hot insoluble fraction (XHI) of a comparative long chain branched polypropylene composition which is obtained by a comparative process which does not use the polyfunctionally unsaturated compound.

The long chain branched polypropylene composition obtained in step v) preferably has:
i) a melt strength F₃₀ (ISO 16790:2005) which is increased, and more preferably increased by at least 3.0% (e.g. in the range of 3.0 to 20% or 5.0 to 20%), and
ii) a xylene hot insoluble fraction (XHI) which is reduced by at least 50%, more preferably at least 60%, even more preferably at least 80%, and yet even more preferably at least 90%,
when compared in a comparative test to the melt strength F₃₀ (ISO 16790:2005) and a xylene hot insoluble fraction (XHI) of a comparative long chain branched polypropylene composition which is obtained by a comparative process which does not use the polyfunctionally unsaturated compound.

A skilled person understands how to conduct the comparative test to be suitable for comparing the properties of the test compound with that of the long chain branched polypropylene composition according to one embodiment of the invention. The skilled person knows how to adjust the process parameters and the components of the comparative composition for the comparative test.

The comparative test can require that the long chain branched polypropylene composition and the comparative long chain branched polypropylene composition are obtained by (i) using about the same process parameters (e.g. selected from heating zones in the extruder, pressure in the extruder, screw speed, die pressure, etc.), and (ii) using the same components for the mixture extruded in step v) with the exception that the mixture extruded in step v) does not contain the polyfunctionally unsaturated compound, and (iii) using the same equipment (e.g. extruder). The amount of the polyfunctionally polyfunctionally unsaturated compound of the mixture extruded in step v) is preferably replaced in the comparative test with the same amount of long chain branched polypropylene of step i).

Furthermore, the process as described herein can achieve one or more specific effects, and preferably can at least partially prevent a certain loss in melt strength of the melt-extruded components when compared in a comparative test to the properties of the long chain branched polypropylene provided in step i) as a single component that is melt extruded under otherwise identical conditions.

The long chain branched polypropylene composition obtained in step v) preferably has a melt strength F₃₀ (ISO 16790:2005) which is increased, and more preferably increased by at least 3.0% (e.g. in the range of 3.0 to 20% or 5.0 to 20%),
when compared in a comparative test to the a melt strength F₃₀ (ISO 16790:2005) of a comparative long chain branched polypropylene composition which is obtained by melt extruding the long chain branched polypropylene provided in step i) as a single component under otherwise identical conditions.

A skilled person understands how to select the conditions for the comparative test to be suitable for comparing the properties of the test compound with that of the long chain branched polypropylene composition according to one embodiment of the invention.

“Otherwise identical conditions” can be understood in this context in that it is required that the inventive long chain branched polypropylene composition and the comparative long chain branched polypropylene composition are obtained using about the same process parameters (e.g. selected from heating zones in the extruder, pressure in the extruder, screw speed, die pressure, etc.), and the same equipment (e.g. extruder, etc.).

The long chain branched polypropylene composition obtained in step v) preferably has
a xylene hot insoluble fraction (XHI) which is reduced by at least 50%, more preferably at least 60%, even more preferably at least 80%, and yet even more preferably at least 90%,
when compared in a comparative test to the xylene hot insoluble fraction (XHI) of a comparative long chain branched polypropylene composition which is obtained by melt extruding the long chain branched polypropylene provided in step i) as a single component under otherwise identical conditions.

More preferably, the long chain branched polypropylene composition obtained in step v) has:
i) a melt strength F₃₀ (ISO 16790:2005) which is increased, and more preferably increased by at least 3.0%, and
ii) a xylene hot insoluble fraction (XHI) which is reduced by at least 50%, more preferably at least 60%, even more preferably at least 80%, and yet even more preferably at least 90%,
when compared in a comparative test to the melt strength F₃₀ (ISO 16790:2005) and the xylene hot insoluble fraction (XHI) of a comparative long chain branched polypropylene composition which is obtained by melt extruding the long chain branched polypropylene provided in step i) as a single component under otherwise identical conditions.

The long chain branched polypropylene composition obtained in step v) preferably comprises a long chain branched polypropylene in an amount of at least 95.0 wt. % (e.g. 95.0 to 100 wt. %), preferably at least 97.5 wt. %, and more preferably at least 98.0 wt. %, based on the total weight of the long chain branched polypropylene composition. Hence, the process as described herein can be a process for preparing a long chain branched polypropylene.

The long chain branched polypropylene composition can comprise a long chain branched polypropylene in an amount of at least 99.0 wt. %, based on the total weight of the long chain branched polypropylene composition. The long chain branched polypropylene composition may essentially consist of, or may consist of, a long chain branched polypropylene.

### Long Chain Branched Polypropylene Composition

In one aspect of the present invention, a long chain branched polypropylene composition is provided, the long chain branched polypropylene composition being obtainable by melt extruding a mixture comprising:
(a) a long chain branched polypropylene,
(b) a polyfunctionally unsaturated compound, and
(c) optionally a radical initiator.

According to one preferred embodiment, the long chain branched polypropylene composition is obtainable by the process as described herein. The long chain branched polypropylene (a) is preferably defined as the long chain branched polypropylene provided in step i) of the process as described herein. The polyfunctionally unsatured compound (b) is preferably defined as the polyfunctionally unsaturated compound provided in step ii) of the process as described herein.

The long chain branched polypropylene composition is preferably a reaction product of the long chain branched polypropylene, the polyfunctionally unsaturated compound, and the optional radical initiator. In case the a polyfunctionally unsaturated (meth) acrylate compound is used as component (b), the long chain branched polypropylene composition preferably comprises subgroups, like carbonyl groups, which are detectable by infrared (IR) spectroscopy.

The long chain branched polypropylene composition typically has specific properties.

The long chain branched polypropylene composition can have a melt flow rate MFR₂ (ISO 1133, 2.16 kg load, 230° C.) in the range of 3.0 to 30 g/10 min, preferably in the range of 5.0 to 25.0 g/10 min, and more preferably of 8.0 to 20.0 g/10 min, like in the range of 10.0 to 20.0 g/10 min.

The long chain branched polypropylene composition can have a melt strength F₃₀ (ISO 16790:2005) in the range of 3.0 to 25.0 cN, preferably in the range of 4.0 to 15.0 cN, and more preferably in the range of 4.0 to 7.5 cN, like in the range of 5.0 to 6.5 cN.

The long chain branched polypropylene composition can have a melt extensibility v₃₀ (ISO 16790:2005) in the range of 200 to 290 mm/s, preferably in the range of 220 to 290 mm/s, and more preferably in the range of 240 to 280 mm/s, like in the range of 240 to 275 mm/s.

The long chain branched polypropylene composition can have a xylene hot insoluble fraction (XHI) of less than 0.10 wt. %, preferably of less than 0.05 wt. %, and more preferably of less than 0.02 wt. %, based on the total weight of the long chain branched polypropylene composition.

The long chain branched polypropylene composition provided in step v) can have a specific combination of properties. Preferably, the long chain branched polypropylene composition has two or more, and more preferably all of the following properties:
i) a melt flow rate MFR₂ (ISO 1133, 2.16 kg load, 230° C.) in the range of 3.0 to 30 g/min, preferably in the range of 5.0 to 25.0 g/10 min, and more preferably of 8.0 to 20.0 g/10 min, like in the range of 10.0 to 20.0 g/10 min,
ii) a melt strength F₃₀ (ISO 16790:2005) in the range of 3.0 to 25.0 cN, preferably in the range of 4.0 to 15.0 cN, and more preferably in the range of 4.0 to 7.5 cN, like in the range of 5.0 to 6.5 cN,
iii) a melt extensibility v₃₀ (ISO 16790:2005) in the range of 200 to 290 mm/s, preferably in the range of 220 to 290 mm/s, and more preferably in the range of 240 to 280 mm/s, like in the range of 240 to 275 mm/s.

According to one embodiment, the long chain branched polypropylene composition has the following properties:
i) a melt flow rate MFR₂ (ISO 1133, 2.16 kg load, 230° C.) in the range of 3.0 to 30 g/min, preferably in the range of 5.0 to 25.0 g/10 min, and more preferably of 8.0 to 20.0 g/10 min, like in the range of 10.0 to 20.0 g/10 min,
ii) a melt strength F₃₀ (ISO 16790:2005) in the range of 3.0 to 25.0 cN, preferably in the range of 4.0 to 15.0 cN, and more preferably in the range of 4.0 to 7.5 cN, like in the range of 5.0 to 6.5 cN,
iii) a melt extensibility v₃₀ (ISO 16790:2005) in the range of 200 to 290 mm/s, preferably in the range of 220 to 290 mm/s, and more preferably in the range of 240 to 280 mm/s, like in the range of 240 to 275 mm/s, and
iv) a xylene hot insoluble fraction (XHI) of less than 0.10 wt. %, preferably of less than 0.05 wt. %, and more preferably of 0.02 wt. % or less, like in the range of 0.0 to 0.02 wt. % based on the total weight of the long chain branched polypropylene composition.

The long chain branched polypropylene composition preferably comprises a long chain branched polypropylene in an amount of at least 95.0 wt. % (e.g. 95.0 to 100 wt. %), preferably at least 97.5 wt. %, and more preferably at least 98.0 wt. %, based on the total weight of the long chain branched polypropylene composition.

The long chain branched polypropylene composition can comprise a long chain branched polypropylene in an amount of at least 99.0 wt. %, based on the total weight of the long chain branched polypropylene composition. The long chain branched polypropylene composition may essentially consist of, or may consist of, a long chain branched polypropylene.

### Use

In another aspect, the invention provides a use of a polyfunctionally unsaturated compound for reducing the loss of melt strength of a long-chain branched polypropylene, and preferably a reused long chain branched polypropylene, during melt extrusion.

The polyfunctionally unsaturated compound and the long chain branched polypropylene is preferably defined as described herein in connection with the long chain branched polypropylene provided in step i) and the polyfunctionally unsaturated compound provided in step ii).

“Reducing the loss of melt strength of a long chain branched polypropylene” is preferably to be understood in that a long chain branched polypropylene composition, which is obtained by melt extruding a mixture comprising the polyfunctionally unsaturated compound in combination with the long chain branched polypropylene, has a melt strength F₃₀ (ISO 16790:2005) which is increased, and preferably increased by at least 3.0% (e.g. in the range of 3.0 to 20% or 5.0 to 20%),
when compared in a comparative test to the melt strength F₃₀ (ISO 16790:2005) of a comparative long chain branched polypropylene composition which is obtained by melt extruding the same mixture comprising the long chain branched polypropylene, however with requirement that the mixture does not contain the polyfunctionally unsaturated compound.

A skilled person understands how to conduct the comparative test to be suitable for comparing the properties of the test compound with that of the long chain branched polypropylene composition according to one embodiment of the inventive use. The skilled person knows how to adjust the process parameters and the components of the comparative composition for the comparative test.

The comparative test can require that the long chain branched polypropylene composition and the comparative long chain branched polypropylene composition are obtained by (i) using about the same process parameters (e.g. selected from heating zones in the extruder, pressure in the extruder, screw speed, die pressure, etc.), and (ii) using the same components for the mixture being extruded with the exception that the mixture does not contain the polyfunctionally unsaturated compound, and (iii) using the same equipment (e.g. extruder). The amount of the polyfunctionally polyfunctionally unsaturated compound is preferably replaced in the comparative test with the same amount of the long chain branched polypropylene.

In addition, the use of the polyfunctionally unsaturated compound can comprise a use for reducing the xylene hot insoluble fraction (XHI) of a long chain branched polypropylene, and preferably a reused long chain branched polypropylene.

“Reducing the xylene hot insoluble fraction (XHI) of a long chain branched polypropylene” is preferably to be understood in that a long chain branched polypropylene composition, which is obtained by melt extruding a mixture comprising the polyfunctionally unsaturated compound in combination with the long chain branched polypropylene, has a xylene hot insoluble fraction (XHI) which is reduced by at least 50%, more preferably at least 60%, even more preferably at least 80%, and yet even more preferably at least 90%,
when compared in a comparative test to the xylene hot insoluble fraction (XHI) of a comparative long chain branched polypropylene composition which is obtained by melt extruding the same mixture comprising the long chain branched polypropylene, however with requirement that the mixture does not contain the polyfunctionally unsaturated compound.

The polyfunctionally unsaturated compound is preferably used in a mixture as defined herein in connection with the mixture provided in step iv). Hence, it is possible that the polyfunctionally unsaturated compound is used in combination with a radical initiator. The radical initiator is preferably defined as described herein for the radical initiator which is optionally provided in step iii).

The use of the polyfunctionally unsaturated compound preferably comprises the provision of a long chain branched polypropylene composition as defined herein.

The invention also provides a process for reducing the loss of melt strength of long chain branched polypropylene during melt extrusion, wherein the process uses a polyfunctionally unsaturated compound.

Preferably, the process comprises the steps of:
combining a long chain branched polypropylene with a polyfunctionally unsaturated compound, and optionally with a radical initiator, to provide a mixture,
melt extruding the mixture.

Additionally, the process may be a process for reducing the xylene hot insoluble fraction (XHI) of a long chain branched polypropylene.

The process preferably provides a long chain branched polypropylene composition as defined herein above in section “Step v)” and in section “Long chain branched polypropylene composition”.

With regard to the effects “for reducing the loss of melt strength” and “for reducing the xylene hot insoluble fraction (XHI)”, is referred to the explanations and definitions provided herein above.

The long chain branched polypropylene, the polyfunctionally unsaturated compound, the optional radical initiator and the melt extruded mixture are preferably defined as described herein above for steps i) to iv) of the process. Thus, the long chain branched polypropylene used in conjunction with the use or the process for reducing the loss of melt strength of long chain branched polypropylene during melt extrusion is preferably defined as defined herein above in section “Step i)”. The polyfunctionally unsaturated compound used in conjunction with the use or the process for reducing the loss of melt strength of long chain branched polypropylene during melt extrusion is preferably defined as defined herein above in section “Step ii)”. The optional radical initiator used in conjunction with the use or the process for reducing the loss of melt strength of long chain branched polypropylene during melt extrusion is preferably defined as defined herein above in section “Step iii)”. The mixture to be melt extruded in conjunction with the use or the process for reducing the loss of melt strength of long chain branched polypropylene during melt extrusion is preferably as described herein in section “Step iv)”.

In the following, the invention is described by specific examples which shall not be construed in limiting the invention in any way.

### EXAMPLES SECTION

### Methods

### Melt Flow Rate (MFR)

The melt flow rates MFR have been determined according to ISO 1133 under a load of 2.16 kg and at a temperature of 230° C.

### Melt Strength F30 and Melt Extensibility v30

The test described herein follows ISO 16790:2005. The tests were carried out at a pressure of 30 bar.

The strain hardening behaviour is determined by the method as described in the article “Rheotens-Mastercurves and Drawability of Polymer Melts”, M. H. Wagner, Polymer Engineering and Sience, Vol. 36, pages 925 to 935. The content of the document is included by reference. The strain hardening behaviour of polymers is analysed by Rheotens apparatus (product of Göttfert, Siemensstr.2, 74711 Buchen, Germany) in which a melt strand is elongated by drawing down with a defined acceleration.

The Rheotens experiment simulates industrial spinning and extrusion processes. In principle a melt is pressed or extruded through a round die and the resulting strand is hauled off. The stress on the extrudate is recorded, as a function of melt properties and measuring parameters (especially the ratio between output and haul-off speed, practically a measure for the extension rate). For the results presented below, the materials were extruded with a lab extruder HAAKE Polylab system and a gear pump with cylindrical die (L/D=6.0/2.0 mm). The gear pump was pre-adjusted to a strand extrusion rate of 5 mm/s, and the melt temperature was set to 200° C. The spinline length between die and Rheotens wheels was 80 mm. At the beginning of the experiment, the take-up speed of the Rheotens wheels was adjusted to the velocity of the extruded polymer strand (tensile force zero): Then the experiment was started by slowly increasing the take-up speed of the Rheotens wheels until the polymer filament breaks. The acceleration of the wheels was small enough so that the tensile force was measured under quasi-steady conditions. The acceleration of the melt strand drawn down is 120 mm/sec². The Rheotens was operated in combination with the PC program EXTENS. This is a real-time data-acquisition program, which displays and stores the measured data of tensile force and drawdown speed. The end points of the Rheotens curve (force versus pulley rotary speed) is taken as the F₃₀ melt strength and drawability values.

### Xylene Hot Insoluble Fraction (XHI)

About 2 g of the polymer (mₚ) are weighted and put in a mesh of metal which is weighted (mₚ₊ₘ). The polymer in the mesh is extracted in a soxhlet apparatus with boiling xylene for 5 hours. The eluent is then replaced by fresh xylene and the boiling is continued for another hour. Subsequently, the mesh is dried and weighted again (m_{XHI+m}). The mass of the xylene hot insoluble fraction (m_{XHI}) obtained by the formula m_{XHI+m}−mₘ=M_{XHI} is put in relation to the weight of the polymer (mₚ) to obtain the fraction of xylene insolubles m_{XHI}/mₚ.

### Materials

### Long Chain Branched Polypropylene

The long chain branched polypropylene was a reused long chain branched polypropylene (BPP) which was obtained by melt extruding once the commercial product Daploy WB140HMS by Borealis in a ZSK 18 twin screw extruder (melt temperature of 200° C. and production rate of 7 kg/h). The reused long chain branched polypropylene (reused BPP) had a melt flow rate MFR₂ (ISO 1133, 2.16 kg load, 230° C.) of 3.9 g/10 min, a melt strength F₃₀ (ISO 16790:2005) of 26 cN, and a melt extensibility v₃₀ (ISO 16790:2005) of 268 mm/s.

### Polyfunctionally Unsaturated Compound

The polyfunctionally unsaturated compound (PUC) was trimethylolpropane triacrylate (TMPTA, CAS No. 15625-89-5) supplied by SigmaAldrich.

### Radical Initiator

The radical initiator (INI) was an organic peroxide radical initiator, namely a tert-butylperoxy isopropyl carbonate supplied as Trigonox® BPIC-C75 by Akzo Nobel.

### Linear Polypropylenes (Reference Materials)

Three different linear polypropylenes (LPP) were subjected to a melt extrusion process using a twin-screw extruder in order to collect reference data for properties of linear polypropylenes before extrusion (b.e.) and after extrusion (a.e.). The reference data is shown in table 1 below:

TABLE 1
Properties of LPP reference materials before
extrusion (b.e.) and after extrusion (a.e.).

| | | LPP-1 | | LPP-2 | | LPP-3 | |
|---|---|---|---|---|---|---|---|
| | | b.e. | a.e. | b.e. | a.e. | b.e. | a.e. |
| MFR₂ | g/10 min | 0.26 | 0.37 | 3.06 | 3.78 | 13.31 | 14.72 |
| F30 | cN | 54.8 | 30.5 | 6.7 | 5.2 | 1.7 | 0.9 |
| v30 | mm/s | 155 | 168 | 170 | 171 | 180 | 181 |

LPP-1: propylene homopolymer available as BE50 from Borealis AG
LPP-2: propylene homopolymer available as HC600TF from Borealis AG
LPP-3: propylene homopolymer available as HE125MO from Borealis AG

### EXAMPLES

Examples IE1 to IE5 and CE1 were prepared by melt extruding the long chain branched polypropylene (BPP) with or without the polyfunctionally unsaturated compound (PUC), and optionally in combination with the radical initiator (INI), in a ZSK 18 twin screw extruder with a melt temperature of 200° C. and a production rate of 7 kg/h. Table 2 shows the recipes and the properties of the examples.

TABLE 2
Recipe and performance of IEs and CE

| | | CE1 | IE1 | IE2 | IE3 | IE4 | IE5 |
|---|---|---|---|---|---|---|---|
| BPP | wt. % | 100 | 99.8 | 99.6 | 99.4 | 99.593 | 99.53 |
| PUC | wt. % | | 0.2 | 0.4 | 0.6 | 0.4 | 0.4 |
| INI | wt. % | | | | | 0.007 | 0.07 |
| MFR₂ | g/10 min | 11 | 12 | 12 | 11 | 13 | 19 |
| XHI | wt. % | 0.13 | 0.01 | 0 | 0 | 0.01 | 0 |
| F30 | cN | 5 | 5.6 | 5.7 | 5.8 | 5.8 | 5.2 |
| V30 | mm/s | 264 | 262 | 263 | 261 | 262 | 270 |

As can be seen from example CE1, the melt strength F₃₀ further decreases from 26 cN of the reused BPP to 5 cN and the melt flow rate MFR₂ further increases from 3.9 g/10 min for the reused BPP to 11 g/10 min after the second extrusion. The gel content, as indicated by xylene hot insoluble (XHI), is 0.13 wt. %.

When the long chain branched polypropylene is extruded in the presence of the polyfunctionally unsaturated compound in examples IE1 to IE5, the melt strength F30 does not drop as much as in example CE1. Thus, examples IE1 to IE5 show a reduced loss of melt strength when compared to example CE1. Furthermore, the gel content is decreased in examples IE1 to IE5 to almost 0 wt. % or to 0 wt. %. When using the radical initiator in examples IE4 and IE5, the melt flow rate MFR is increased.

Furthermore, examples IE1 to IE5 provide compositions having a melt extensibility V30 of 261 mm/s or more, a MFR of 11 g/10 min or more, and a melt strength F30 of 5.2 cN or more. This combination of rheological properties clearly indicates that a long chain branched polypropylene composition is obtained in all of examples IE1 to IE5. Indeed, a comparison with the linear polypropylenes as reference materials described in table 1 shows marked differences in rheological properties. All LPP reference materials show a melt extensibility of below 200 mm/s and show a drastic decrease of melt strength F30 with increasing MFR. For example, I-PP3 has an MFR of about 13 g/10 min (b.e.) and a melt strength F30 of less than 2 cN. These rheological properties are characteristic for linear polypropylenes.

1. A process for preparing a long chain branched polypropylene composition, the process comprises:
i) providing a long chain branched polypropylene,
ii) providing a polyfunctionally unsaturated compound,
iii) optionally providing a radical initiator,
iv) combining the long chain branched polypropylene, the polyfunctionally unsaturated compound, and the optional radical initiator, to provide a mixture,
v) melt extruding the mixture to obtain a long chain branched polypropylene composition.

2. The process according to claim 1, wherein the long chain branched polypropylene is a reused long chain branched polypropylene.

3. The process according to claim 1, wherein the long chain branched polypropylene is a long chain branched propylene homopolymer.

4. The process according to claim 1, wherein the long chain branched polypropylene has one or more of the following properties:
i) a melt flow rate MFR₂ (ISO 1133, 2.16 kg load, 230° C.) in the range of 0.5 to 10 g/10 min,
ii) a melt strength F₃₀ (ISO 16790:2005) in the range of 5.0 to 50.0 cN,
iii) a melt extensibility v₃₀ (ISO 16790:2005) in the range of 200 to 300 mm/s.

5. The process according to claim 1, wherein the polyfunctionally unsaturated compound is a polyfunctional (meth)acrylate compound.

6. The process according to claim 1, wherein the mixture provided in step iv) comprises a radical initiator.

7. The process according to claim 1, wherein step iii) is not carried out, and the mixture provided in step iv) does not contain a radical initiator.

8. The process according to claim 1, wherein the mixture provided in step iv) comprises
(a) 95.0 to 99.95 wt. %, of the long chain branched polypropylene,
(b) 0.05 to 5.0 wt. %, of the polyfunctionally unsaturated compound, and
(c) optionally 0.0001 to 0.20 wt. %, of a radical initiator,
wherein all weight amounts are based on the overall weight of the mixture provided in step iv), and optionally wherein the weight amounts of components (a) to (c) add up to 100 wt. %.

9. The process according to claim 1, wherein the mixture provided in step iv) comprises the components provided in step i) to iii) in the relative amounts of:
(a) 95.0 to 99.95 parts by weight (pbw),
(b) 0.05 to 5.0 parts by weight (pbw), and
(c) optionally 0.0001 to 0.20 parts by weight (pbw), of a radical initiator.

10. The process according to claim 1, wherein the long chain branched polypropylene composition obtained in step v) has a melt strength F₃₀ (ISO 16790:2005) which is increased,
when compared in a comparative test to the melt strength F₃₀ (ISO 16790:2005) of a comparative long chain branched polypropylene composition which is obtained by a comparative process which does not use the polyfunctionally unsaturated compound, and/or
wherein the long chain branched polypropylene composition obtained in step v) has a xylene hot insoluble fraction (XHI), which is reduced by at least 50%,
when compared in a comparative test to the xylene hot insoluble fraction (XHI) of a comparative long chain branched polypropylene composition which is obtained by a comparative process which does not use the polyfunctionally unsaturated compound.

11. The process according to claim 1, wherein the long chain branched polypropylene composition obtained in step v) has one or more of the following properties:
i) a melt flow rate MFR2 (ISO 1133, 2.16 kg load, 230° C.) in the range of 3.0 to 30 g/10 min,
ii) a melt strength F₃₀ (ISO 16790:2005) in the range of 3.0 to 25.0 cN,
iii) a melt extensibility v₃₀ (ISO 16790:2005) in the range of 200 to 290 mm/s.

12. A long chain branched polypropylene composition, the long chain branched polypropylene composition being obtainable by melt extruding a mixture comprising:
(a) a long chain branched polypropylene,
(b) a polyfunctionally unsaturated compound, and
(c) optionally a radical initiator.

13. The long chain branched polypropylene composition according to claim 12, wherein the long chain branched polypropylene composition has one or more of the following properties:
i) a melt flow rate MFR₂ (ISO 1133, 2.16 kg load, 230° C.) in the range of 3.0 to 30 g/10 min,
ii) a melt strength F₃₀ (ISO 16790:2005) in the range of 3.0 to 25.0 cN, preferably in the range of 4.0 to 15.0 cN, and more preferably in the range of 4.0 to 7.5 cN,
iii) a melt extensibility v₃₀ (ISO 16790:2005) in the range of 200 to 290 mm/s.

14. The long chain branched polypropylene composition according to claim 12, wherein the long chain branched polypropylene composition has a xylene hot insoluble fraction (XHI) of less than 0.10 wt. %, based on the total weight of the long chain branched polypropylene composition.

15. The long chain branched polypropylene composition according claim 12, wherein the long chain branched polypropylene composition comprises at least 95.0 wt. % of a long chain branched polypropylene, based on the total weight of the long chain branched polypropylene composition.

16. (canceled)

17. A process for reducing the loss of melt strength of long chain branched polypropylene during melt extrusion, the process comprising:
combining a long chain branched polypropylene with a polyfunctionally unsaturated compound, and optionally with a radical initiator, to provide a mixture,
melt extruding the mixture.

18. The process of claim 1, wherein the long chain branched polypropylene has the following properties:
i) a melt flow rate MFR₂ (ISO 1133, 2.16 kg load, 230° C.) in the range of 0.5 to 10 g/10 min,
ii) a melt strength F₃₀ (ISO 16790:2005) in the range of 5.0 to 50.0 cN, and
iii) a melt extensibility v₃₀ (ISO 16790:2005) in the range of 200 to 300 mm/s.

19. The process according to claim 5, wherein the polyfunctional (meth) acrylate compound is a polyfunctional acrylate monomer.

20. The process according to claim 6, wherein the radical initiator is an organic peroxide radical initiator.

21. The long chain branched polypropylene composition according to claim 12, wherein the long chain branched polypropylene composition has the following properties:
i) a melt flow rate MFR₂ (ISO 1133, 2.16 kg load, 230° C.) in the range of 3.0 to 30 g/10 min,
ii) a melt strength F₃₀ (ISO 16790:2005) in the range of 3.0 to 25.0 cN, and
iii) a melt extensibility v₃₀ (ISO 16790:2005) in the range of 200 to 290 mm/s.
